(19) United States
(12) Patent Application Publication
(10) Pub. No.: US 2015/0142506 A1
(43) Pub. Date: May 21, 2015

(54) Account Health Assessment, Risk Identification, and Remediation

(71) Applicant: INTERNATIONAL BUSINESS MACHINES CORPORATION, Armonk, NY (US)

(72) Inventors: Asheesh Kumar, Bangalore (IN); Ramesh Chandra Pathak, Bangalore (IN); Suryanarayana K. Rao, Bangalore (IN)

(73) Assignee: INTERNATIONAL BUSINESS MACHINES CORPORATION, Armonk, NY (US)

(21) Appl. No.: 14/082,427

(22) Filed: Nov. 18, 2013

(51) Int. Cl. G06Q 10/06

(52) U.S. Cl. CPC G06Q 10/0635
USPC 705/7.28

(57) ABSTRACT

A method and system for determining account health, identifying and rating hidden and visible risks, and identifying remediation actions in response to identified risks and as a means to improve account health scores is provided. The method includes retrieving metrics associated with a customer account of a customer. Aggregated metrics from the metrics and additional aggregated metrics are generated and stored. Weighting factors are applied to the aggregated metrics and the additional aggregated metrics. Attributes of events and symptoms of incidents are modeled to identify best fit & possible root causes. In response, overall health & risk scores for the customer account are calculated

### FIELD

The present invention relates generally to a method for determining a health of an account, identifying risks in the account, assessing the impact of the risks, and suggesting a remediation action and in particular to a method and associated system for providing a remedy based on account health determination.

### BACKGROUND

Determining system issues typically includes an inaccurate process with little flexibility. Correcting system issues may include a complicated process that may be time consuming and require a large amount of resources. Accordingly, there exists a need in the art to overcome at least some of the deficiencies and limitations described herein above.

### SUMMARY

A first aspect of the invention provides a method comprising: retrieving, by a computer processor of a computing system from a plurality of sources, metrics associated with a customer account of a customer; generating, by the computer processor, aggregated metrics from said metrics with respect to the plurality of sources; generating, by the computer processor, additional aggregated metrics from metrics associated with additional accounts of the customer, wherein the additional aggregated metrics are aggregated with respect to additional sources; storing, by the computer processor within a repository data storage warehouse, the aggregated metrics and the additional aggregated metrics; retrieving, by the computer processor, the aggregated metrics and the additional aggregated metrics; applying, by the computer processor executing a weighting engine, weighting factors to the aggregated metrics and the additional aggregated metrics, wherein the weighting factors are associated with criticality and importance factors; and calculating, by the computer processor based on the weighting factors applied to the aggregated metrics and the additional aggregated metrics, overall health and risk scores for the customer account and the additional accounts with respect to the specified platforms and the additional platforms, wherein the overall health and risk scores are associated with specified time periods.

A second aspect of the invention provides a computing system comprising a computer processor coupled to a computer-readable memory unit, the memory unit comprising instructions that when executed by the computer processor implements a method comprising: retrieving, by the computer processor from a plurality of sources, metrics associated with a customer account of a customer; generating, by the computer processor, aggregated metrics from the metrics with respect to the plurality of sources; generating, by the computer processor, additional aggregated metrics from metrics associated with additional accounts of the customer, wherein the additional aggregated metrics are aggregated with respect to additional sources; storing, by the computer processor within a repository data storage warehouse, the aggregated metrics and the additional aggregated metrics; retrieving, by the computer processor, the aggregated metrics and the additional aggregated metrics; applying, by the computer processor executing a weighting engine, weighting factors to the aggregated metrics and the additional aggregated metrics, wherein the weighting factors are associated with criticality and importance factors; and calculating, by the computer processor based on the weighting factors applied to the aggregated metrics and the additional aggregated metrics, overall health and risk scores for the customer account and the additional accounts with respect to the specified platforms and the additional platforms, wherein the overall health and risk scores are associated with specified time periods.

A third aspect of the invention provides a computer program product, comprising a computer readable hardware storage device storing a computer readable program code, the computer readable program code comprising an algorithm that when executed by a computer processor of a computer system implements a method, the method comprising: retrieving, by the computer processor from a plurality of sources, metrics associated with a customer account of a customer; generating, by the computer processor, aggregated metrics from the metrics with respect to the plurality of sources; generating, by the computer processor, additional aggregated metrics from metrics associated with additional accounts of the customer, wherein the additional aggregated metrics are aggregated with respect to additional sources; storing, by the computer processor within a repository data storage warehouse, the aggregated metrics and the additional aggregated metrics; retrieving, by the computer processor, the aggregated metrics and the additional aggregated metrics; applying, by the computer processor executing a weighting engine, weighting factors to the aggregated metrics and the additional aggregated metrics, wherein the weighting factors are associated with criticality and importance factors; and calculating, by the computer processor based on the weighting factors applied to the aggregated metrics and the additional aggregated metrics, overall health and risk scores for the customer account and the additional accounts with respect to the specified platforms and the additional platforms, wherein the overall health and risk scores are associated with specified time periods.

The present invention advantageously provides a simple method and associated system capable of determining system issues.

### BRIEF DESCRIPTION OF THE DRAWINGS

FIG. 1, including FIGS. 1A and 1B, illustrates a system for providing an account health assessment, in accordance with embodiments of the present invention.

FIG. 2, including FIGS. 2A and 2B, illustrates an internal functional view of the integrated health assessment engine of FIG. 1, in accordance with embodiments of the present invention.

FIG. 3, including FIGS. 3A and 3B, illustrates multiple vehicles communicating with each other for dynamically generating and associating a generated speed limit with a recommended lane assignment, in accordance with embodiments of the present invention.

FIG. 3 illustrates a deployment view of the root cause analyzer of FIG. 2, in accordance with embodiments of the present invention.

FIG. 5 illustrates a computer apparatus used by the system of FIG. 1 for providing an account health assessment, in accordance with embodiments of the present invention.

### DETAILED DESCRIPTION

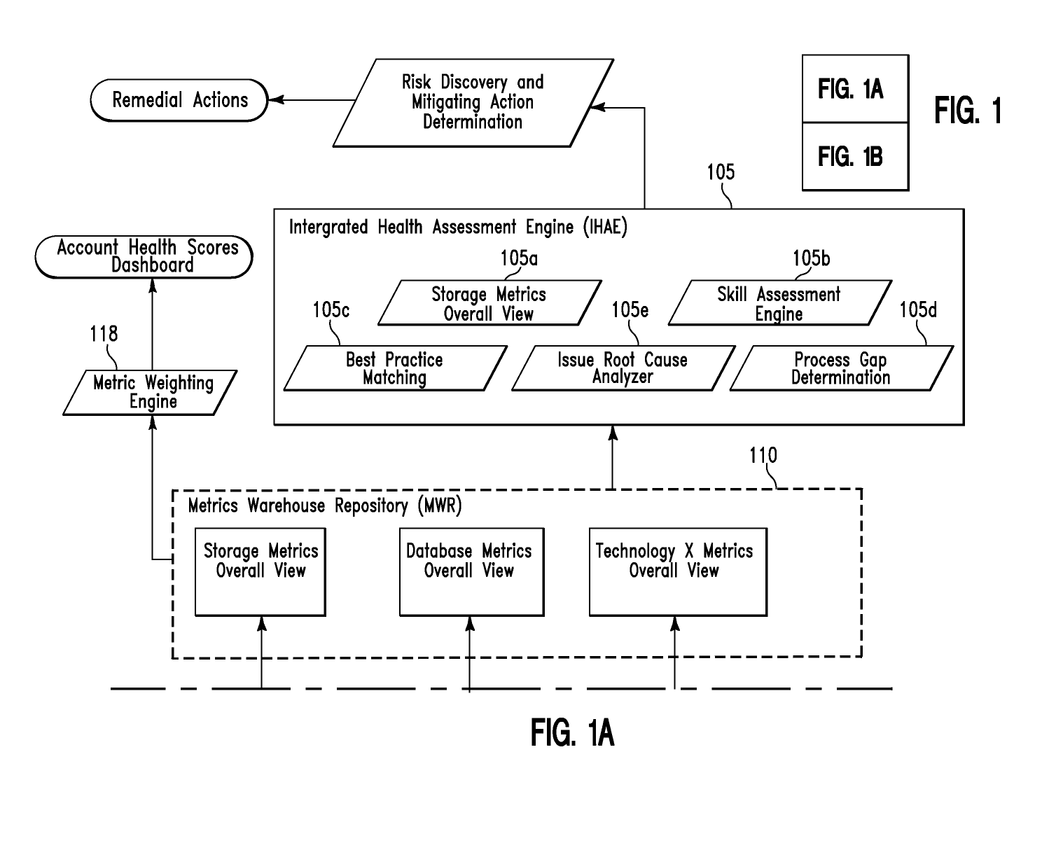

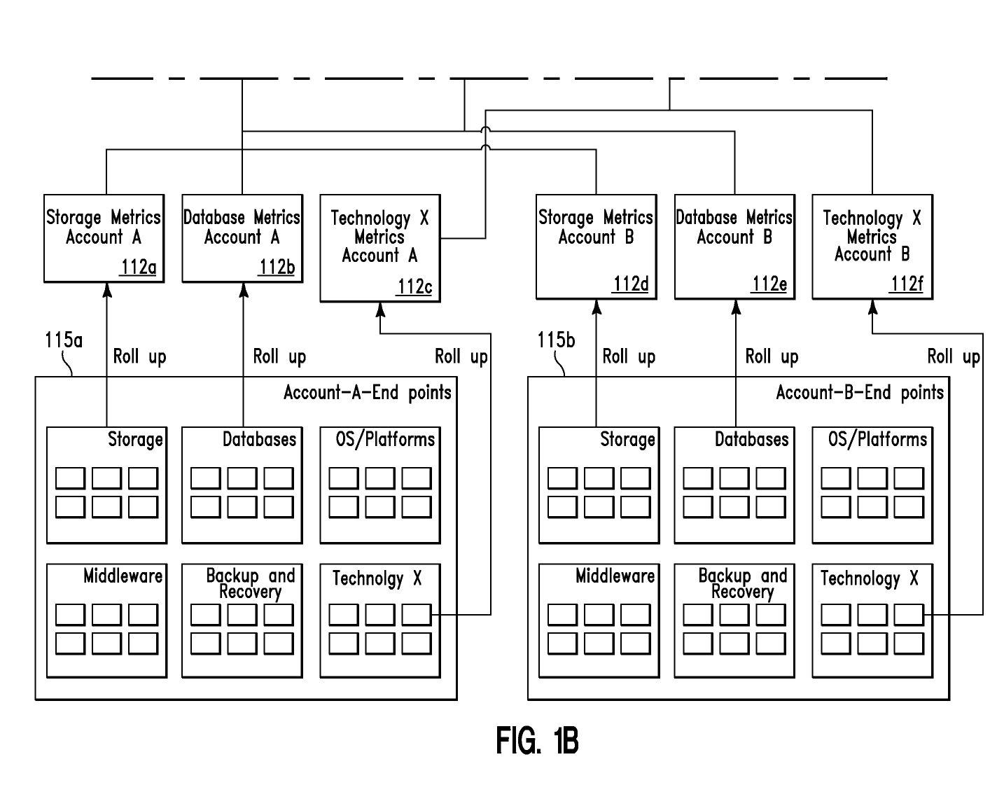

FIG. 1, including FIGS. 1A and 1B, illustrates a system 100 for providing an account health assessment, in accordance with embodiments of the present invention. System 100 enables a method for providing a consolidated account health assessment involving a combination of root cause analysis, a risk assessment, skill gap identification, and remedial action recommendation with respect to large scale data. The method for providing a consolidated account health assessment and risk identification includes performing a consolidated assessment comprising a combination of root cause analysis, risk assessment, skill gap identification, and remedial action recommendation on large scale data by collecting metrics during the occurrence of events across multiple services and identifying matching metrics across the events to provide suitable solutions.

System 100 provides an integrated mechanism for collecting metrics from various end points, technologies, and across various times to provide consolidated dashboards for account health, risk identification, and remedial actions thereby identifying probable root causes for incidents and events affecting one or more end points etc. System 100 performs the following processes:
1. Collecting metrics from all end points for all platforms (e.g., databases, middleware, operating systems, storage arrays, backup servers, etc.). p0 2. Roll-up of the metrics for the end points by platform. Roll-up of the metrics comprises aggregating all individually collected metrics by platform within each account. For example, all database metrics for account A are aggregated, all storage metrics for account A are aggregated, etc.
3. A second level roll up of the metrics indicating a process for aggregating all platform metrics across all supported customer accounts.
3. All collected metrics (individual/granular as well as aggregated) are fed into an integrated health assessment engine 105 (as described in detail, infra). Additionally, all collected metrics are fed into a metrics weighing engine 118. The metrics weighing engine 118 allocates different weightings to different metrics (in order of criticality and importance) and calculates overall health scores for each account and each platform for given time lines (i.e., for specified months, weeks, days, etc.).

System 100 comprises an integrated health assessment engine 105 retrieving metrics 112a . . . 112f, via a metric warehouse repository 110, from endpoint components 115a and 115b for an account A. End point components 115a and 115b may comprise, inter alia, databases, application servers, a servers, virtual machines, storage arrays, backup media servers, middleware, monitoring servers, etc. Integrated health assessment and risk identification engine 105 performs the following functions: a root cause analysis, a risk identification process, a skill gap identification process, and a remedial recommendation analysis. Integrated health assessment and risk identification engine 105 comprises a technical remediation engine 105a, a skill assessment engine 105b, a best practice matching component 105c, a process gap component 105d, and a root cause analyzer 105e.

Metric warehouse repository 110C comprises metric values from for comparison with suggested and permissible metric value ranges to identify risks with associated ratings. The associated ratings are stored allowing a systematic and automated discovery of risks and possible mitigating actions.

Skill assessment engine 105b identifies events and incidents which have not been resolved within recommended mean time to resolve values. Skill assessment engine 105b additionally matches an incident category and sub-category to a required skill level. If a repeated pattern (based on pre-determined thresholds) of violated mean time to resolve values for events is detected, possible skill gaps are identified as areas for potential improvements. The skill gaps are identified by evaluating the root causes, a component type, a severity of an event/incident, and an incident category and subcategory

Root cause analyzer 105e evaluates collected metrics 112a . . . 112f and provides technical remediation recommendations, skill gap analysis, and potential root causes for events and incidents occurring in customer accounts. Root cause analyzer 105e matches an issue (or event), based on metrics collected at a time of the occurrence of the an incident to identify matching occurrences proceeds to issue known recommendations based on matched metrics, a variance in metric values between occurrence of the event from and an occurrence of a similar event across all customer accounts. Therefore, root cause analyzer identifies potential root causes from two sources of data thereby providing the ability to recommend regression of metrics from their baselines and identify remediation actions.

System 100 enables the following method:
1. Defining metrics for each component type.
2. Customizing metrics per service line/technology and account/customer
3. Collecting the metrics.
4. Collecting incidents/events occurring for each component.
5. Storing the metrics in metrics warehouse repository 110 across the following dimensions: service line /technology, account name, geography, and time.
6. Parsing the collected metrics to identify risks.
7. Parsing the identified risks through a historical warehouse across accounts and a time to look for mitigating and remedial actions.
8. Parsing incidents/event trails to retrieve known and relevant remediation recommendations based on a matching algorithm.
9. Parsing incident resolution metrics via skill assessment engine 105b to determine skill gaps and recommendations.
10. Roll-up of the component metrics to a service line level per account.
11. Roll-up of account level service line metrics to geography and global levels.
12. Matching metrics across technologies to discover inter-dependencies and risk relationships.
13. Generating dashboards representing account health status across various dimensions.
14. Discovering risks and 14 and recommending associated risk remedial and mitigating actions
15. Identifying skill gaps and recommending associated remedial actions.
16. Producing possible root causes for incidents and events.

System 100 provides an IT infrastructure services provider that supports multiple customers (known as accounts). Each of the accounts comprise a number of end point components contracted by the IT infrastructure services provider to support and maintain.

System 100 depicts a process for the collection of metrics from each of end point components 112a . . . 112f for each service line/technology. The metrics collected for each component type will vary. Additionally, there may be several metrics common to multiple component types. Metrics are further grouped into categories such as performance, availability, backups, monitoring, capacity management, business continuity, and component hygiene. Each of the categories is measured by collecting metrics classified as being pertinent to an associated category. Depending on a variance and/or deviation of the collected metrics from associated permissible limits (or range of values), a rating is derived for each metric based on pre-determined metric weighting scales. All rated metrics for a category (i.e., when rolled-up or aggregated) produce a rating at the category level for that specific end point component (i.e., of end point components 112a . . . 112f). End point category ratings are rolled up to produce an overall rating for an associated end point (i.e., of end point components 112a . . . 112f). Simultaneously, category ratings for all end point components 112a . .. 112f for a specific service line are rolled up to produce a single category rating for the entire service line for a specific customer account. Category ratings are further rolled up to a country, geographical, or global level. The roll up mechanisms and methods detailed above provide the ability to mathematically arrive at ratings for the health of a particular service line, account, or geography and presentable as dashboards to management teams of IT service providers.

The dashboards are based on actual statistical and point-in time data stored in metrics warehouse repository 110 to determine exact underlying metrics that contributed to an associated rating thereby providing the ability to generate informed metric-based decisions as where to direct remedial actions and resources to achieve greatest overall rating improvements.

Additionally, integrated health assessment engine 105 comprises technical remediation engine 105a, skill assessment engine 105b, and root cause analyzer 105e for evaluating collected metrics and providing technical remediation recommendations, skill gap analysis, potential root causes for events and incidents occurring in customer accounts.

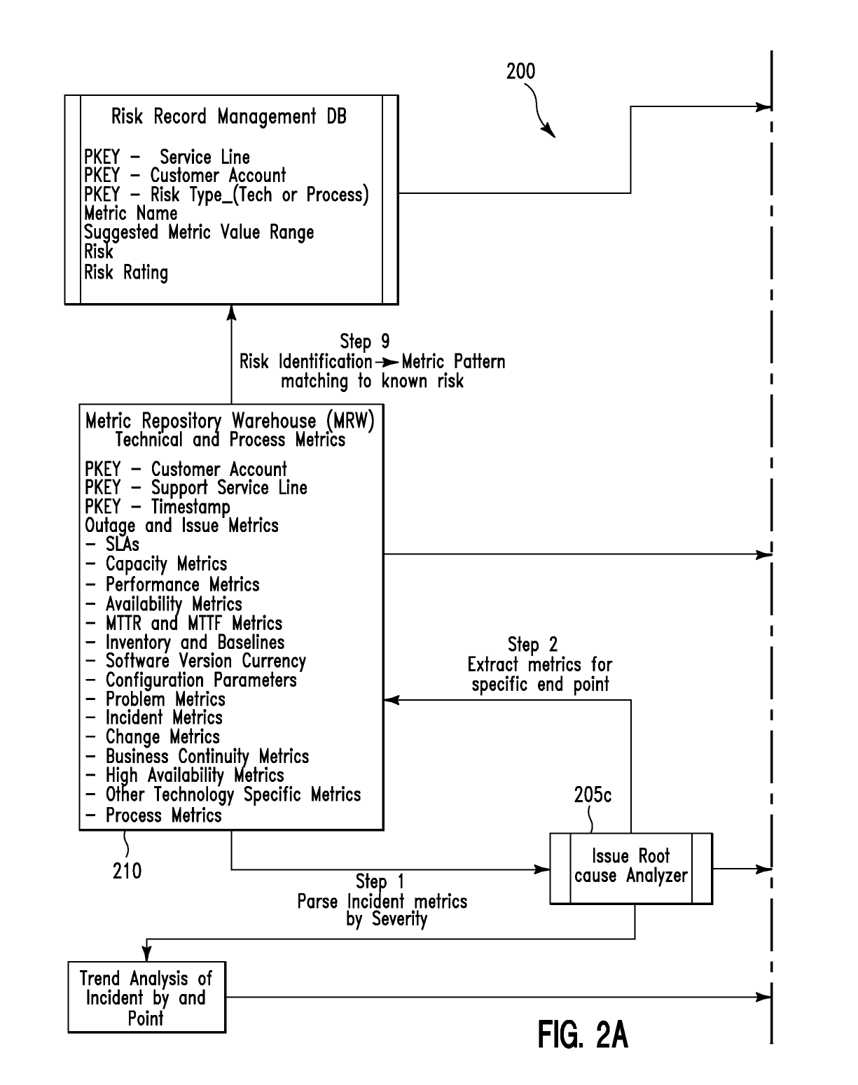

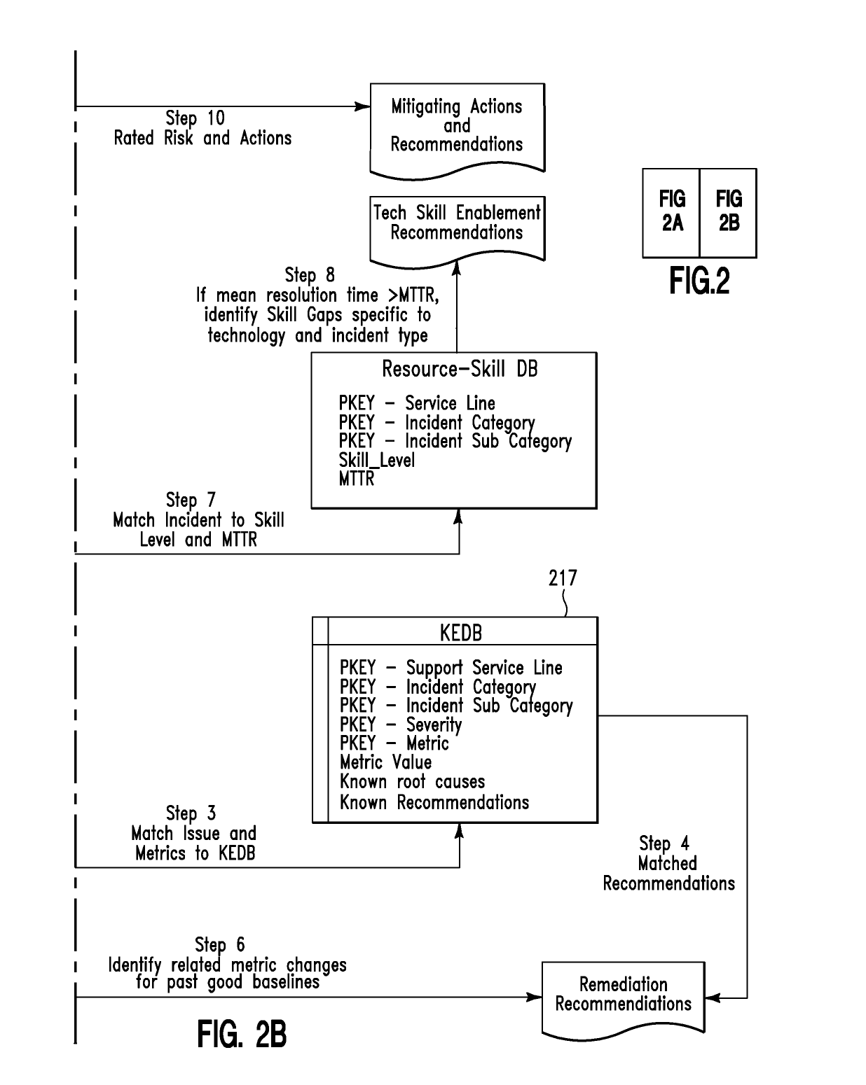

FIG. 2, including FIGS. 2A and 2B, illustrates an internal functional view 200 of integrated health assessment engine 105 of FIG. 1, in accordance with embodiments of the present invention. Integrated health assessment engine 105 is enabled to perform the following key functions: a root cause analysis, a risk identification process, a skill gap identification process, and a remedial action recommendation process. All metrics collected from each end point (i.e., endpoint components 115a and 115b of FIG. 1) for all service lines and in each customer account are stored as a time series in metrics warehouse repository 210. Step 1 in FIG. 2 comprises parsing (by severity) incident and event metrics through root cause analyzer 205e. In Step 2, metric values at a time of the event occurrence are fetched from metrics warehouse repository 210 for further analysis. In Step 3, root cause analyzer 205e matches an issue (or event), based on metrics collected at a time of the occurrence of an incident, with a knowledge database (KEDB) 217 to identify matching occurrences. In step 4, known recommendations are issued based on matched metrics, a variance in metric values between an occurrence of the event from metrics warehouse repository 210, and an occurrence of a similar event across all customer accounts. In step 5, the root cause analyzer 205e matches the event with a similar historical event from a same end point in an effort to identify metric similarities and changes in metric baselines resulting in an occurrence of the event. Therefore, root cause analyzer 205e identifies potential root causes from two sources of data, KEDB 217 and metrics warehouse repository 210. In step 6, a recommended regression of the metrics from associated baselines is provided. In step 9, metric values from metrics warehouse repository 210 are compared to suggested and permissible metric value ranges to identify risks with associated ratings stored in the risk record management database 212 thereby allowing a systematic and automated discovery of risks and possible mitigating actions. In steps 7 and 8, events and incidents that have not been resolved within recommended mean time to resolve (MTTR) values are identified and the incident category and sub-category is matched to a required skill level. Additionally, if a repeated pattern (based on pre-determined thresholds) of violated MTTR for events is observed, possible skill gaps are identified as areas for potential improvements. The skill gaps are identified by evaluating root causes, component type, severity of the event/incident, and incident category and sub-category.

Internal functional view 200 comprises the following markers: an incident symptom marker and a root cause marker. An incident symptom marker comprises a unique marker associated with each incident. A root cause marker of an incident is expressed as a non-linear model depending on a number of variants. There could be multiple model fits for a particular incident.

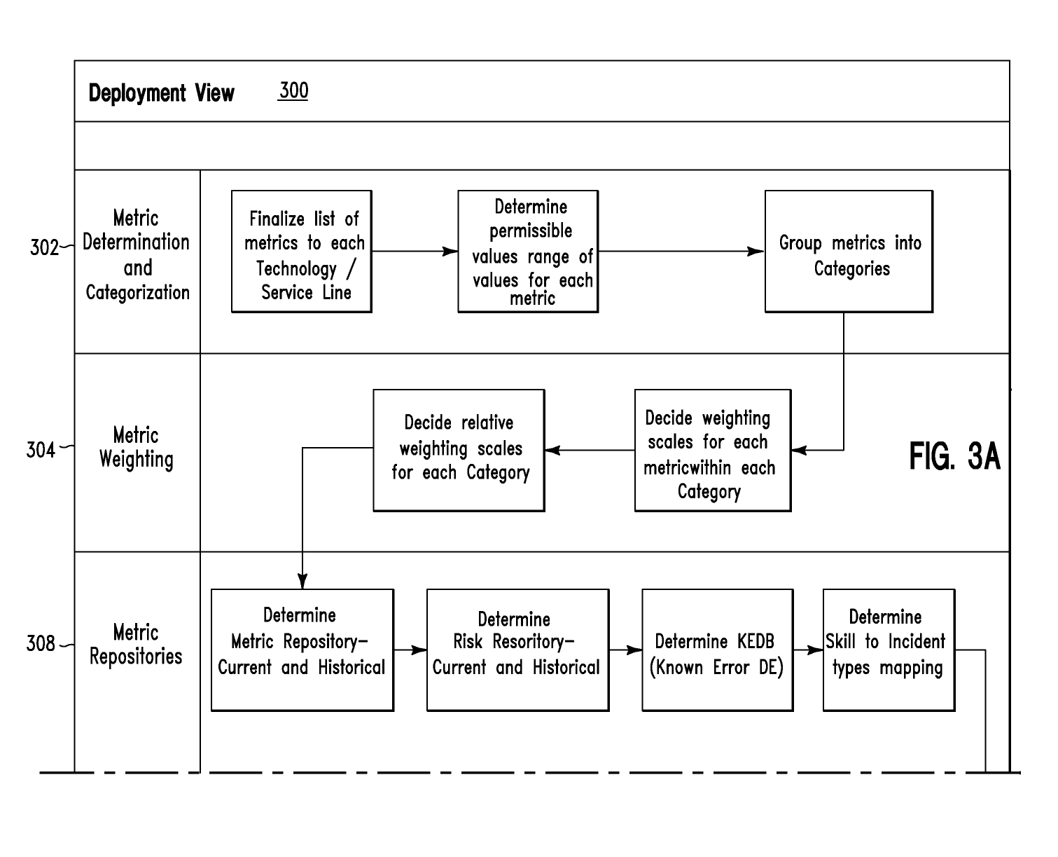

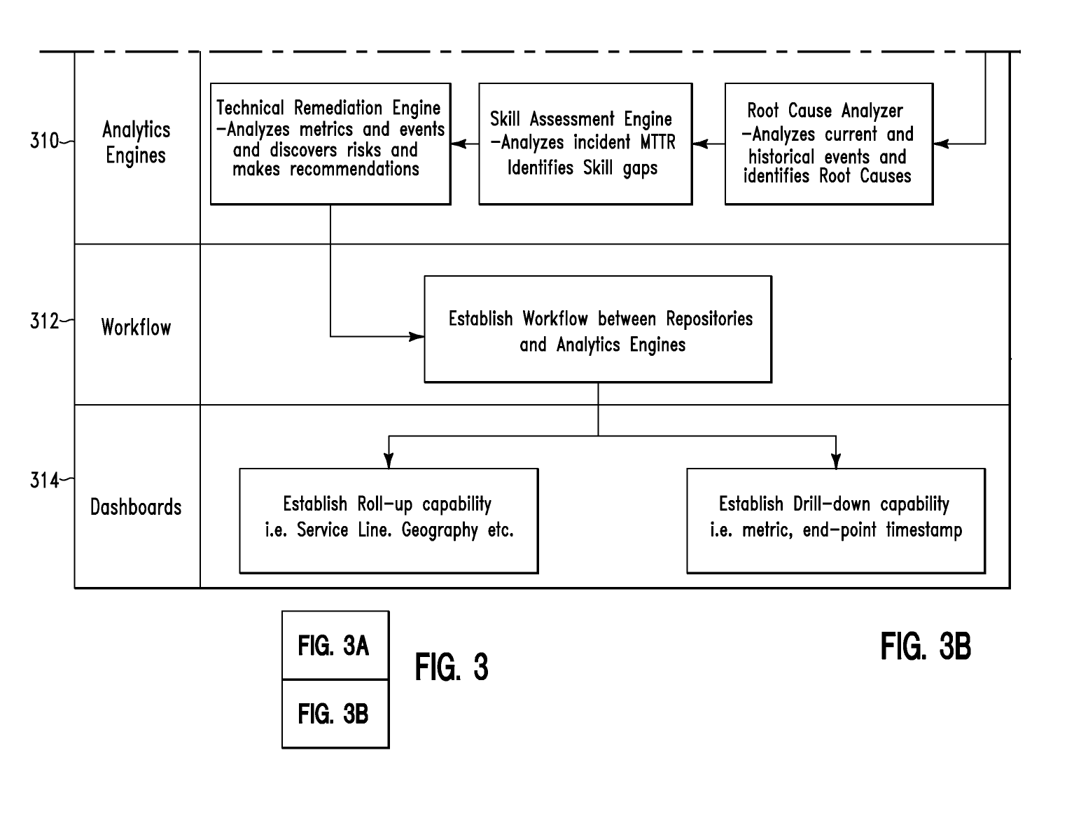

FIG. 3, including FIGS. 3A and 3B, illustrates a deployment view 300 of root cause analyzer 205e of FIG. 2, in accordance with embodiments of the present invention. Deployment view 300 illustrates a metric categorization component 302, a metric weighting component 304, metric repositories 308, analytics engines 310, a workflow component 312, and a dashboard component 314. Metric categorization component 302 finalizes a list of metrics, determines associated values, and groups the metrics into categories. Metric weighting component 304 determines weighting scales for each category and associated metrics. Metric repositories 308 comprise metrics, risks, known errors, and skill to incident mapping. Analytics engines 310 comprise a technical remediation engine, a skill assessment engine, and root cause analyzer 205e. Workflow component 312 is configured to establish a workflow between metric repositories 308 and analytics engines 310. Dashboards 314 establish roll up capacity and drill down capacity.

Root cause analyzer 205e determines a cause(s) related to an incident or issue affecting a source (e.g., an end point) directly or indirectly. The incident or issue is referred to as a root cause. Root cause analyzer 205e executes an algorithm for identifying root causes by fitting symptoms of an incident (i.e., a Symptom marker) into existing or new models. A symptom marker is defined herein as a unique marker associated with an incident. The root cause of an incident (i.e., a root cause (RC) marker) may be expressed as a non-linear model depending on a number of variants. An incident or issue typically affects a single end point and associated dependent end points. An RC marker may comprise a combination of variants across dependent end points as well as a main affected end point. Therefore, an incident symptom marker and RC markers may be modeled as time series functions of:
1. Metrics & statistics on a main affected end point (M, S).
2. Metrics & Statistics on dependent end points (Md, Sd).
3. Level of dependency between an affected end point and related end points (d).
4. An end point Type (of Main affected end point & dependent end points) (Et).
5. Time (T)

The incident symptom marker and RC markers may be modeled as a different combination of function 1 as follows:

### Function 1

Function(M1, M2, . . . , S1, S2, . . . ,

F1(d1, Md1a, Md1a, . . . , Sd1a, Sd1b, . . . , En), F2(d2, Md2a, Md2b, . . . , Sd2a, Sd2b, . . . , Et2),

T).

The following steps describe a process (executed by root cause analyzer 205e) for identifying actions based on the incident symptom marker and root cause markers.
1. Incident symptom markers are identified for each incident. The symptom markers are associated with a specific incident at a specific point in time.
2. Related end points are determined based on pre-established dependency maps and levels of dependency.
3. Metrics are extracted from all related end points. For example endpoints may include, inter alia, network components, storage components, databases, middleware, applications, servers, etc.
4. Collected metrics are passed to analytics engines 310.
5. Analytics engine performs the following functions:
   A. Transmitting metrics to available non-linear models.
   B. Allocating importance factors to the metrics from dependent end points depending on an end point type a level of dependency.
   B. Providing models for the metrics.
   C. Determining model ranking based on a number of past fits to a same set of metric variants (e.g., if the metrics fit 10 models, determine which of the 10 models has caused a maximum number of incidents with similarity in the incident markers).
   D. Eliminating model fits obtained with no change in metrics (i.e., with variance ±x %).
   E. Determining a metric which comprising a maximum impact.
   F. Determining a list of root cause markers from shortlisted models.
   G. Testing the short listed models by replacing high impact metrics (discovered) earlier with baseline values to determine if it meets the following conditions: variants no longer fitting into any root cause markers or variants no longer fitting into an associated incident symptom marker.
   H. Producing a list of metrics in an order of contribution to an incident and test success rate (i.e., ranked in the order of probability of the incident occurrence for different combinations of metrics across dependent end points and end point types).
   I. Feeding root cause models (as functions of combinations of metric variants across end point types) to the analytics engines 310 as a root cause for the incident which analytics engines 310 could not determine via modeling methods.
6. Identifying remedial actions from the knowledge database (KEDB) 217 for the short listed root causes.

FIG. 4 illustrates an algorithm detailing a process flow enabled by system 100 of FIG. 1 for providing an account health assessment, in accordance with embodiments of the present invention. Each of the steps in the algorithm of FIG. 4 may be enabled and executed in any order by a computer processor executing computer code. In step 400, metrics associated with a customer account of a customer are retrieved from a plurality of sources. The plurality of sources may include, inter alia, a plurality of endpoints of specified platforms, applications, tools, processes, documents, databases, middleware, operating systems, storage arrays, backup servers, network components, SAN, etc. In step 402, aggregated metrics fare generated from the metrics with respect to the plurality of sources. Additionally, additional aggregated metrics are generated from metrics associated with additional accounts of the customer. The additional aggregated metrics are aggregated with respect to additional sources. In step 404, weighting factors are applied to the aggregated metrics and the additional aggregated metrics. The weighting factors are associated with criticality and importance factors. In step 408, overall health scores for the customer account and the additional accounts are calculated (based on the weighting factors applied to the aggregated metrics and the additional aggregated metrics) with respect to specified platforms. The said overall health scores are associated with specified time periods. In step 410, incident metrics of the aggregated metrics and the additional aggregated metrics are determined. In step 412, the incident metrics and associated issues are matched to incident data of an incident database. In step 414, recommended metrics are determined based on results of step 412. In step 418, incident markers for specified incidents associated with sources of the plurality of sources are determined. In step 420, related sources are determined. In step 422, a first group of metrics are extracted from the related sources. In step 424, the first group of metrics and the incident markers are applied to a plurality of non-linear models. In step 428, root causes of the specified incidents are determined based on results of step 424.

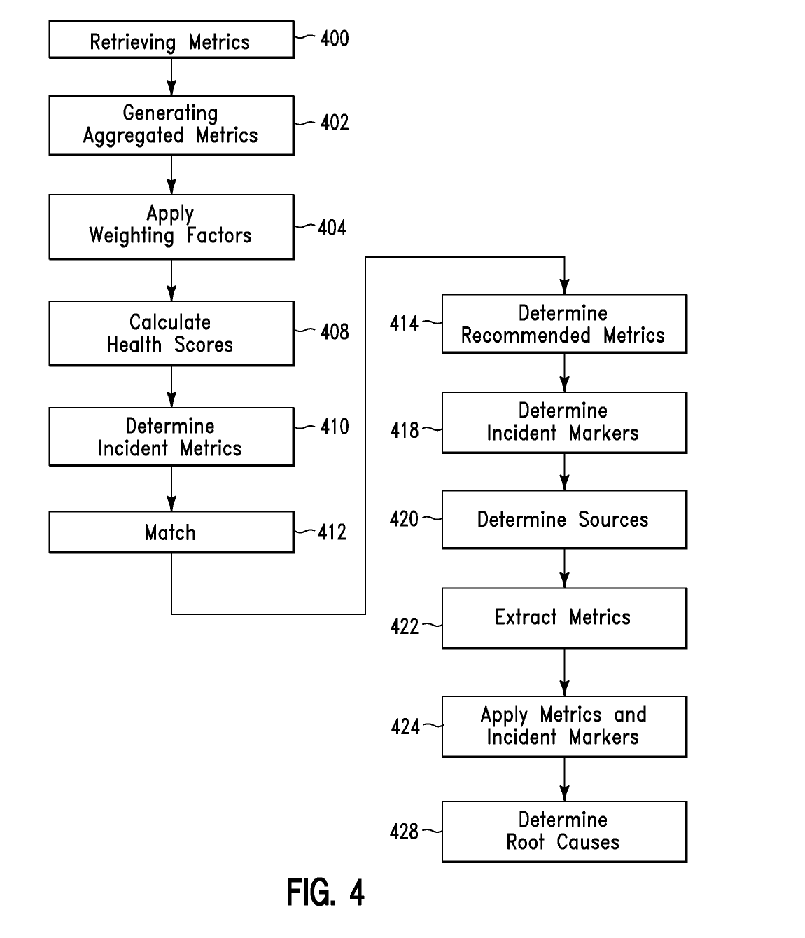

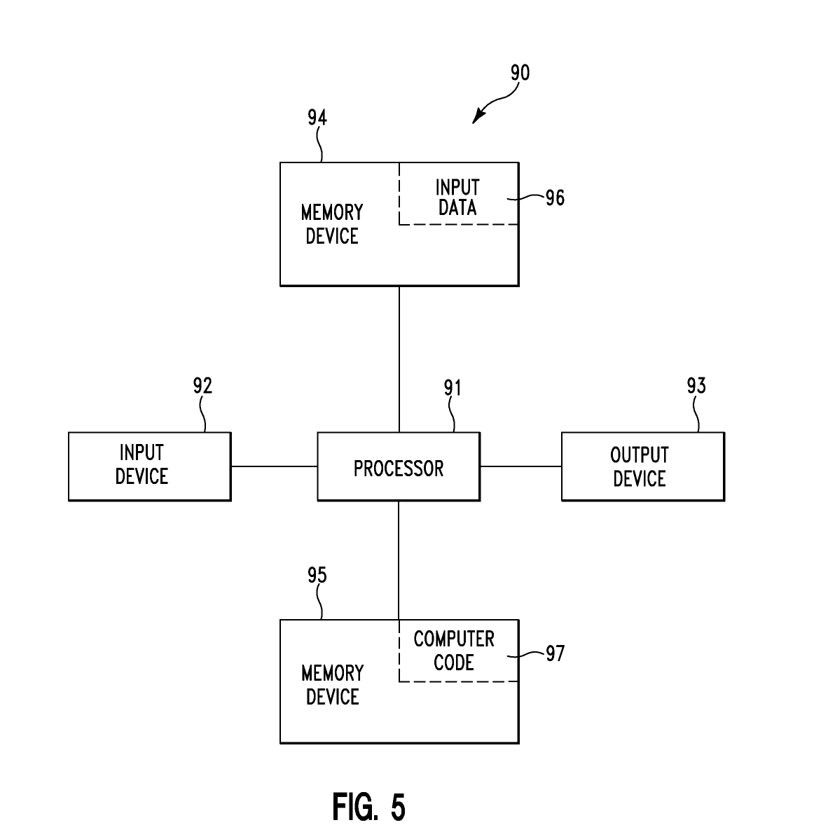

FIG. 5 illustrates a computer apparatus 90 used by system 100 of FIG. 1 for providing an account health assessment, in accordance with embodiments of the present invention. The computer system 90 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 4) for providing an account health assessment. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may include the algorithm of FIG. 4 and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

Still yet, any of the components of the present invention could be created, integrated, hosted, maintained, deployed, managed, serviced, etc. by a service supplier who offers to provide an account health assessment. Thus the present invention discloses a process for deploying, creating, integrating, hosting, maintaining, and/or integrating computing infrastructure, including integrating computer-readable code into the computer system 90, wherein the code in combination with the computer system 90 is capable of performing a method for providing an account health assessment. In another embodiment, the invention provides a business method that performs the process steps of the invention on a subscription, advertising, and/or fee basis. That is, a service supplier, such as a Solution Integrator, could offer to provide an account health assessment. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
retrieving, by a computer processor of a computing system from a plurality of sources, metrics associated with a customer account of a customer;
generating, by said computer processor, aggregated metrics from said metrics with respect to said plurality of sources;
generating, by said computer processor, additional aggregated metrics from metrics associated with additional accounts of said customer, wherein said additional aggregated metrics are aggregated with respect to additional sources;
storing, by said computer processor within a repository data storage warehouse, said aggregated metrics and said additional aggregated metrics;
retrieving, by said computer processor, said aggregated metrics and said additional aggregated metrics;
applying, by said computer processor executing a weighting engine, weighting factors to said aggregated metrics and said additional aggregated metrics, wherein said weighting factors are associated with criticality and importance factors; and
calculating, by said computer processor based on said weighting factors applied to said aggregated metrics and said additional aggregated metrics, overall health and risk scores for said customer account and said additional accounts with respect to specified platforms and additional platforms, wherein said overall health and risk scores are associated with specified time periods.

2. The method of claim 1, further comprising:
determining, by said computer processor, incident metrics of said aggregated metrics and said additional aggregated metrics;
matching, by said computer processor, said incident metrics and associated issues to incident data of an incident database;
determining, by said computer processor based on a historical analysis, previously modified metrics associated with said customer account and said additional accounts;
determining, by said computer processor based on results of said matching and said previously modified metrics, recommended metrics.

3. The method of claim 2, further comprising:
extracting, by said computer processor, specified incident metrics of said incident metrics, wherein said specified incident metrics are associated with a specified endpoint of a plurality of endpoints of said plurality of sources.

4. The method of claim 3, further comprising:
matching, by said computer processor, a metric pattern of said specified incident metrics to associated risks of said customer account;
rating, by said computer processor, said associated risks with respect to corrective actions; and
generating, by said computer processor based on results of said matching and said rating, associated actions and recommendations.

5. The method of claim 4, further comprising:
aggregating, by said computer processor, said associated risks based on technology, said customer, a business domain, a system, subsystems, an application, and an environment;
automatically identifying, by said computer processor based on said aggregating, available best practices and solutions for said associated risks; and
performing , by said computer processor, a percentage fitment analysis and feasibility analysis with respect to said available best practices and solutions for said associated risks.

6. The method of claim 3, further comprising:
matching, by said computer processor, said specified incident metrics to a skill level of said customer;
identifying, by said computer processor based on said specified incident metrics, missing skills of said skill level with respect to said customer; and
generating, by said computer processor based on results of said matching and said identifying, recommendations for obtaining skills of said missing skills.

7. The method of claim 1, further comprising:
determining, by said computer processor, values and ranges of values for each metric of said aggregated metrics and said additional aggregated metrics;
generating, by said computer processor based on said values and ranges of values, categories for groups of metrics of said aggregated metrics and said additional aggregated metrics;
determining, by said computer processor, weighting scales for each said metric; and
determining, by said computer processor based on said weighting scales, relative weighting scales for each said metric.

8. The method of claim 1, further comprising:
determining, by said computer processor, levels of dependencies between endpoints of a plurality of endpoints of said plurality of sources; and
determining, by said computer processor based on said levels of dependencies, root causes of said specified incidents.

9. The method of claim 1, wherein said plurality of sources comprise sources selected from the group consisting of a plurality of endpoints of specified platforms, applications, tools, processes, documents, databases, middleware, operating systems, storage arrays, backup servers, network components, and SAN.

10. The method of claim 1, further comprising:
tracking, by said computer processor via a data warehouse, a performance history with respect to progress of a risk mitigation process and a health improvement process with respect to said customer account, an associated technology area, application group, and a business domain.

11. The method of claim 1, further comprising:
tracking, by said computer processor via a data warehouse, a performance history with respect to progress of a risk mitigation process and a health improvement process with respect to systems, subsystems, applications, middleware, and additional dependent components and subcomponents.

12. The method of claim 1, further comprising:
determining, by said computer processor, incident markers for specified incidents associated with sources of said plurality of sources;
determining, by said computer processor, related sources of said plurality of sources;
extracting, by said computer processor from said related sources, a first group of metrics;
applying, by said computer processor, said first group of metrics and said incident markers to a plurality of non-linear models; and
determining, by said computer processor, based on results of said applying said first group of metrics and said incident markers, root causes of said specified incidents.

13. The method of claim 1, further comprising:
identifying, by said computer processor based on said weighting factors applied to said aggregated metrics and said additional aggregated metrics, risks associated with said customer account and said additional accounts with respect to specified platforms and additional platforms;
assessing, by said computer processor based on results of said identifying, impacts associated with said risks; and
determining, by said computer processor based on results of said assessing, remediation actions associated with said risks.

14. The method of claim 1, further comprising:
providing at least one support service for at least one of creating, integrating, hosting, maintaining, and deploying computer-readable code in the computing system, said code being executed by the computer processor to implement: said retrieving said metrics, said generating said aggregated metrics, said generating said additional aggregated metrics, said storing, said retrieving said aggregated metrics and said additional aggregated metrics, said applying, and said calculating.

15. A computing system comprising a computer processor coupled to a computer-readable memory unit, said memory unit comprising instructions that when executed by the computer processor implements a method comprising:
retrieving, by said computer processor from a plurality of sources, metrics associated with a customer account of a customer;
generating, by said computer processor, aggregated metrics from said metrics with respect to said plurality of sources;
generating, by said computer processor, additional aggregated metrics from metrics associated with additional accounts of said customer, wherein said additional aggregated metrics are aggregated with respect to additional sources;
storing, by said computer processor within a repository data storage warehouse, said aggregated metrics and said additional aggregated metrics;
retrieving, by said computer processor, said aggregated metrics and said additional aggregated metrics;
applying, by said computer processor executing a weighting engine, weighting factors to said aggregated metrics and said additional aggregated metrics, wherein said weighting factors are associated with criticality and importance factors; and
calculating, by said computer processor based on said weighting factors applied to said aggregated metrics and said additional aggregated metrics, overall health and risk scores for said customer account and said additional accounts with respect to specified platforms and additional platforms, wherein said overall health and risk scores are associated with specified time periods.

16. The computing system of claim 15, wherein said method further comprises:
determining, by said computer processor, incident metrics of said aggregated metrics and said additional aggregated metrics;
matching, by said computer processor, said incident metrics and associated issues to incident data of an incident database;
determining, by said computer processor based on a historical analysis, previously modified metrics associated with said customer account and said additional accounts;
determining, by said computer processor based on results of said matching and said previously modified metrics, recommended metrics.

17. The computing system of claim 16, wherein said method further comprises:
extracting, by said computer processor, specified incident metrics of said incident metrics, wherein said specified incident metrics are associated with a specified endpoint of a plurality of endpoints of said plurality of sources.

18. The computing system of claim 17, wherein said method further comprises:
matching, by said computer processor, a metric pattern of said specified incident metrics to associated risks of said customer account;
rating, by said computer processor, said associated risks with respect to corrective actions; and
generating, by said computer processor based on results of said matching and said rating, associated actions and recommendations.

19. The computing system of claim 18, wherein said method further comprises:
aggregating, by said computer processor, said associated risks based on technology, said customer, a business domain, a system, subsystems, an application, and an environment;
automatically identifying, by said computer processor based on said aggregating, available best practices and solutions for said associated risks; and
performing , by said computer processor, a percentage fitment analysis and feasibility analysis with respect to said available best practices and solutions for said associated risks.

20. A computer program product, comprising a computer readable hardware storage device storing a computer readable program code, said computer readable program code comprising an algorithm that when executed by a computer processor of a computer system implements a method, said method comprising:
retrieving, by said computer processor from a plurality of sources, metrics associated with a customer account of a customer;
generating, by said computer processor, aggregated metrics from said metrics with respect to said plurality of sources;
generating, by said computer processor, additional aggregated metrics from metrics associated with additional accounts of said customer, wherein said additional aggregated metrics are aggregated with respect to additional sources;
storing, by said computer processor within a repository data storage warehouse, said aggregated metrics and said additional aggregated metrics;
retrieving, by said computer processor, said aggregated metrics and said additional aggregated metrics;
applying, by said computer processor executing a weighting engine, weighting factors to said aggregated metrics and said additional aggregated metrics, wherein said weighting factors are associated with criticality and importance factors; and
calculating, by said computer processor based on said weighting factors applied to said aggregated metrics and said additional aggregated metrics, overall health and risk scores for said customer account and said additional accounts with respect to specified platforms and additional platforms, wherein said overall health and risk scores are associated with specified time periods.
